(19) United States
(12) Patent Application Publication
(10) Pub. No.: US 2025/0347582 A1
(43) Pub. Date: Nov. 13, 2025

(54) MODULAR RETAINING WALL STRUCTURE USED FOR POOL SEGMENTATION OF UNDERWATER VIBRATION TABLE

(71) Applicant: Tianjin University, Tianjin (CN)

(72) Inventors: Qinghua HAN, Tianjin (CN); Yan LU, Tianjin (CN); Jinyuan ZHANG, Tianjin (CN); Haiyang WANG, Tianjin (CN); Zhipeng LI, Tianjin (CN)

(73) Assignee: Tianjin University, Tianjin (CN)

(21) Appl. No.: 19/023,393

(22) Filed: Jan. 16, 2025

(30) Foreign Application Priority Data
May 7, 2024 (CN) 202410553041.7

(51) Int. Cl. G01M 10/00; G01M 7/02

(52) U.S. Cl. CPC G01M 10/00; G01M 7/02

(57) ABSTRACT

A modular retaining wall structure used for pool segmentation of an underwater vibration table includes multiple retaining wall units arranged in a matrix, the retaining wall units include back frame structures and bracket structures, any one of the back frame structures is positioned and connected between the two bracket structures, and water retaining plates are arranged on upstream faces of two sides of the connection between the back frame structures and the bracket structures; and specifically the retaining wall units include N back frame structures and N+1 bracket structures, where N is an integer. The present disclosure has the advantages of ingenious conception, compact and reasonable structure, modular design and being assembled together by plug-in, convenient and efficient installation and use, forming a partition wall with an easily adjustable length, and stronger applicability.

### CROSS REFERENCE TO THE RELATED APPLICATIONS

This application is based upon and claims priority to Chinese Patent Application No. 202410553041.7, filed on May 7, 2024, the entire contents of which are incorporated herein by reference.

### TECHNICAL FIELD

The present disclosure relates to the technical field of underwater vibration tables, and in particular, to a modular retaining wall structure used for pool segmentation of an underwater vibration table.

### BACKGROUND

The test pool of an underwater vibration table can simulate the wading environment such as rivers, ocean currents and waves, and provide a test environment for bridge engineering, marine engineering and port and coastal engineering, to carry out physical model tests. In order to restore the wading environment more realistically, the construction area for the test pool of the underwater vibration table continues to expand. However, for small test objects, the required test area is limited, and the use of a large-area experimental water pool is costly and results in the wastage of water resources. Therefore, it is necessary to use a retaining wall structure to perform area segmentation on the test pool and carry out a small-scale underwater vibration table test to make full use of the pool and minimize the cost of use. At present, the pool segmentation method is mainly by means of masonry and building temporary concrete walls in the test pool, etc. to perform region segmentation, and the method requires a lot of manpower, and it is disposable, high cost, and easy to cause pool pollution, which is not conducive to the promotion of use.

Therefore, it is necessary to develop a modular retaining wall structure for pool segmentation of the underwater vibration table. The structure is connected to each other by embedding, which is convenient for disassembly and easy to reuse materials, avoiding waste of resources; at the same time, by adjusting the number of connections between the bracket structure and the back frame structure, it can be assembled flexibly according to the demand, which expands the applicability of this kind of retaining wall structure and makes it suitable for the segmentation of test areas with different sizes.

### SUMMARY

An objective of the present disclosure is to provide a modular retaining wall structure used for pool segmentation of an underwater vibration table, the modular retaining wall structure realizes a detachable and movable structure of the retaining wall, which is conducive to decreasing the waste of resources and reducing costs, and at the same time, the modular retaining wall structure can meet the requirements of a variety of different test solutions of the underwater vibration table.

In order to solve the above problems, the present disclosure adopts the following technical solutions.

The present disclosure provides a modular retaining wall structure used for pool segmentation of an underwater vibration table, including multiple retaining wall units arranged in a matrix, the retaining wall units include back frame structures and bracket structures, any one of the back frame structures is positioned and connected between the two bracket structures, and water retaining plates are arranged on upstream faces of two sides of the connection between the back frame structures and the bracket structures.

Preferably, the retaining wall units include N back frame structures and N+1 bracket structures, where N is an integer.

Preferably, the bracket structure includes a bottom plate and a steel frame, a bottom of the steel frame is welded with the bottom plate, an exposed end of the bottom plate is tightly connected to embedded parts of a pool bottom plate by bolts, and two sides of the steel frame are connected to water retaining plates of the bracket structures.

Preferably, the steel frame includes frame columns and frame beams, and the frame columns and frame beams are vertically distributed; and the frame columns placed vertically and the frame beams placed horizontally are made of H-shaped steel, and a bottom end of one frame column is positioned and connected to the bottom plate.

Preferably, the back frame structure includes steel trusses and cover plates, one steel truss is welded into a rectangular truss by multiple square pipes, the cover plates are made of square steel plates, the cover plates are arranged at two ends of vertical web rods at the outermost four corners of the rectangular truss, the vertical web rods at the four corners of the rectangular truss are embedded in U-shaped grooves connected to the frame columns placed vertically, and one side of the steel truss is connected to a water retaining plate of the back frame structure.

Preferably, both the water retaining plates of the back frame structures and the water retaining plates of the bracket structures are made of PVC plastic plates, and the water retaining plates of the back frame structures and the water retaining plates of the bracket structures are respectively bonded or rolled on the upstream faces of two sides of the steel truss and steel frame by AB glue.

Preferably, a thickness of the water retaining plates of the back frame structures is set to a sum of a plate thickness of the water retaining plates of the bracket structures and the frame columns.

Preferably, when building the retaining wall, outer sides of the back frame structures located on two sides are closely connected to side walls of the pool, and the bracket structures are arranged at intervals and plugged into the back frame structures.

Compared with the prior art, the present disclosure has beneficial technical effects as follows:

according to the present disclosure, a modular retaining wall structure used for pool segmentation of an underwater vibration table includes multiple retaining wall units arranged in a matrix, the retaining wall units include back frame structures and bracket structures, any one of the back frame structures is positioned and connected between the two bracket structures, and water retaining plates are arranged on upstream faces of two sides of the connection between the back frame structures and the bracket structures.

1) The multi-layer retaining wall units of the present disclosure are arranged from bottom to top to form a segmented wall, which can be used to segment the pool of the underwater vibration table to form test areas with different functions and sizes.

2) The back frame structures and the bracket structures of the present disclosure are connected to each other by adopting the way of embedding, which is convenient for disassembly and easy to reuse materials, avoiding waste of resources.

3) Adjusting the specific number of connections between the bracket structures and the back frame structures can be applied to the underwater vibration table tests of pools with different sizes.

The present disclosure has the advantages of ingenious conception, compact and reasonable structure, modular design and being assembled together by plug-in, convenient and efficient installation and use, forming a partition wall with an easily adjustable length, and stronger applicability; and the retaining wall structure can segment the pool into two areas, during the experiment, water is present in both areas, and the operator uses a certain area for small-scale experimental operations.

### BRIEF DESCRIPTION OF THE DRAWINGS

The following is a further explanation of the present disclosure in combination with a brief description of the drawings.

FIG. 1 is a schematic diagram of a modular retaining wall structure used for pool segmentation of an underwater vibration table of the present disclosure;

FIG. 2 is an enlarged connection diagram of a water retaining plate of a bracket structure and a water retaining plate of a back frame structure of the present disclosure;

FIG. 3 is a schematic diagram of an arrangement of a using state of the present disclosure;

FIG. 4 is a main view of a bracket structure of the present disclosure;

FIG. 5 is a top view of a bracket structure of the present disclosure;

FIG. 6 is a main view of a back frame structure of the present disclosure; and

FIG. 7 is a top view of a back frame structure of the present disclosure.

List of reference characters: 1. bottom plate; 2. bolt; 3. steel frame; 4. steel truss; 5. cover plate; 6. water retaining plate of a bracket structure; and water retaining plate of a back frame structure.

### DETAILED DESCRIPTION OF THE EMBODIMENTS

In order to make the technical problems to be solved, technical solutions and beneficial effects of the present disclosure more clearly understood, the following is a further detailed description of the present disclosure in combination with the drawings and embodiments. It should be understood that the embodiments described here are only used to explain the present disclosure, but are not used to limit the present disclosure.

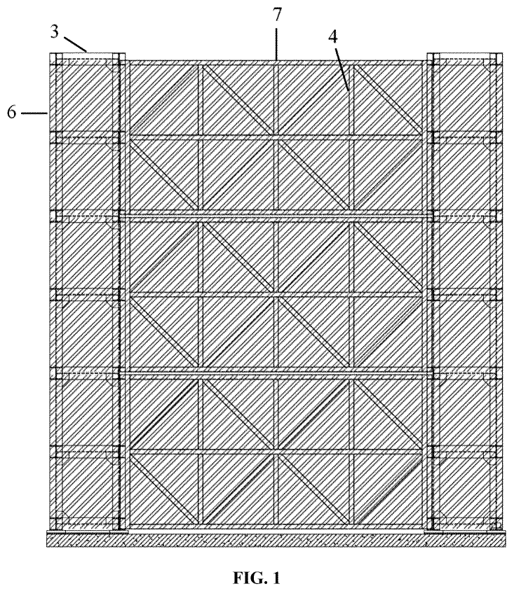

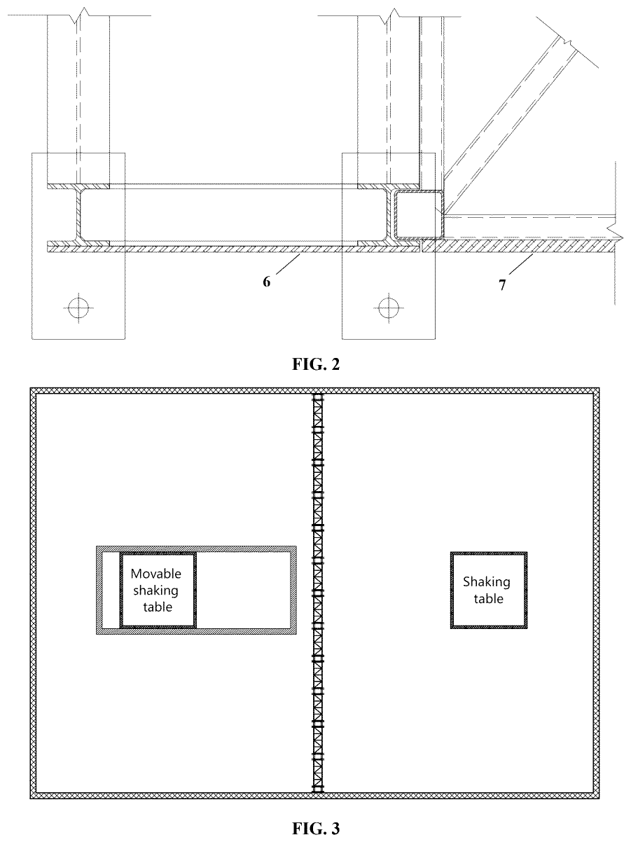

As shown in FIGS. 1-7, a modular retaining wall structure used for pool segmentation of an underwater vibration table includes multiple retaining wall units arranged in a matrix, the retaining wall units include back frame structures and bracket structures, any one of the back frame structures is positioned and connected between the two bracket structures, and water retaining plates are arranged on upstream faces of two sides of the connection between the back frame structures and the bracket structures; and specifically, the retaining wall units include N back frame structures and N+1 bracket structures, where N is an integer. Wherein, a height of the back frame structures and the bracket structures corresponds to a depth of the pool, and is higher than a height of the water surface, so as to realize the effective segmentation of the pool area.

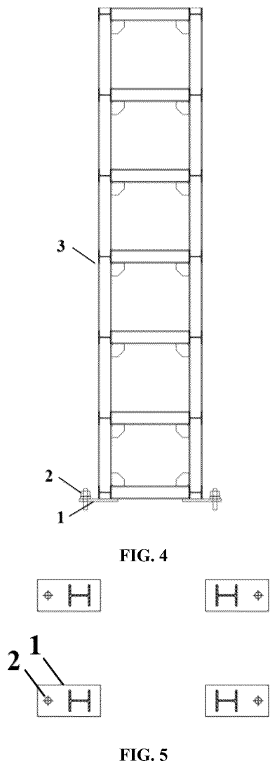

As shown in FIGS. 4-5, the bracket structure includes a bottom plate 1 and a steel frame 3, a bottom of the steel frame 3 is welded with the bottom plate 1, an exposed end of the bottom plate 1 is tightly connected to embedded parts of a pool bottom plate by bolts 2, and two sides of the steel frame 3 are connected to water retaining plates of the bracket structures 6.

Specifically, the steel frame 3 includes frame columns and frame beams, and the frame columns and frame beams are vertically distributed; and the frame columns placed vertically and the frame beams placed horizontally are made of H-shaped steel, a bottom end of the frame columns is positioned and connected to the bottom plate 1, and specifically, welding positioning is adopted. In an embodiment of the present disclosure, H-shaped steel is used symmetrically on left and right sides, skillfully utilizing the characteristics of the steel itself to form U-shaped grooves with the same specification on both sides at the same time. The U-shaped grooves realize a plug-in type connection of the back frame structures and improve assembly efficiency.

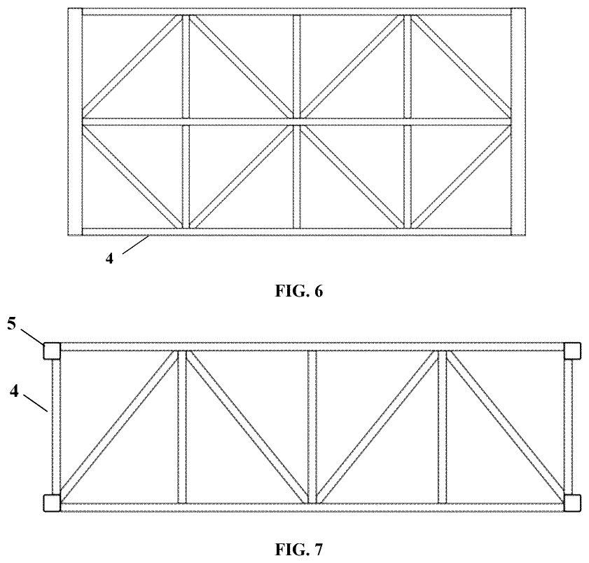

As shown in FIGS. 6-7, the back frame structure includes steel trusses 4 and cover plates 5, one steel truss 4 is welded into a rectangular truss by multiple square pipes, the cover plates 5 are made of square steel plates, the cover plates 5 are arranged at two ends of vertical web rods at the outermost four corners of the rectangular truss, the vertical web rods at the four corners of the rectangular truss are embedded in the U-shaped grooves connected to the frame columns placed vertically, and one side of the steel truss 4 is connected to a water retaining plate of the back frame structure 7.

In one of the embodiments, both the water retaining plates of the back frame structures 7 and the water retaining plates of the bracket structures 6 are made of PVC plastic plates, and the water retaining plates of the back frame structures 7 and the water retaining plates of the bracket structures 6 are respectively bonded or rolled on the upstream faces of two sides of the steel truss 4 and steel frame 3 by AB glue.

Specifically, a thickness of the water retaining plates of the back frame structures is set to a sum of a plate thickness of the water retaining plates of the bracket structures and the frame columns, which ensures the flatness of the upstream faces of two sides of the wall.

Specifically, when building the retaining wall, outer sides of the back frame structures located on two sides are closely connected to side walls of the pool, and the bracket structures are arranged at intervals and plugged into the back frame structures.

The use process of the present disclosure is as follows:

Step 1, preparation work, firstly, according to the design, the basic materials of the back frame structure and the bracket structure are prepared, after cutting, they are welded into multiple standard back frame structures and bracket structures, and the welded back frame structures and bracket structures can be assembled together;

Step 2, positioning connection of the bracket structures to the pool bottom, multiple bracket structures are fixed on embedded parts of the pool bottom plate of the underwater vibration table by bolts 2; each bracket structure is connected with four bottom plates 1, each bottom plate 1 is arranged with a bolt 2; after the positioning of the bracket structures is stable, the water retaining plates 6 of the bracket structures are fixedly connected to both sides of the bracket structures through glue or other binders or binding tapes; and specifically, multiple bracket structures are connected to the embedded parts of the pool bottom plate according to designed positions;

Step 3, assembly of back frame structures, the back frame structures are connected to the bracket structures by means of inserting, and one back frame structure is plugged between each two adjacent bracket structures, after the plugging is completed, the water retaining plates 7 of the back frame structures are fixedly connected to both sides of the back frame structures by glue or other binder or binding tapes; and the thickness of the water retaining plates 7 of the back frame structures is greater than that of the water retaining plates 6 of the bracket structures, and the two are flush when connected; and

Step 4, after the completion of the connection of multiple back frame structures and multiple bracket structures in a horizontal or vertical row, a whole retaining wall unit is formed, and the height of the retaining wall unit corresponds to the depth of the pool.

In general, the modular design of the present disclosure relies on the reasonable arrangement of several modular bracket structures and back frame structures to form a retaining wall, thereby realizing the segmentation of the internal area of the test pool. During the experiment, water is present in both areas, and the operator uses a certain area to carry out small-scale experimental operations; therefore, the retaining wall structure does not need to be hermetically sealed during the segmentation process, and it is sufficient to divide the pool into two or more zones, moreover, each area is arranged with a vibration table, the vibration table can be set up for fixed or mobile options, a vibration table is arranged at an interior of each area, and the vibration table can be set up as a fixed or optional mobile type.

According to the retaining wall units of the present disclosure, the modular design can be disassembled and moved, which is beneficial to reduce the waste of resources and reduce cost, and at the same time, the modular design can make it possible to meet the requirements of a variety of different test solutions for the underwater vibration table, with stronger applicability.

It is important to note that in this article, relational terms such as first and second are used only to distinguish an entity or operation from another entity or operation, and do not necessarily require or imply the existence of any such actual relationship or order between those entities or operations. Moreover, the term ‘include’, ‘comprise’ or any other variation thereof is intended to cover non-exclusive inclusion, thereby making a process, method, article or device that includes a range of elements not only include those elements, but also include other elements that are not clearly listed, or include the inherent elements of the process, method, object or equipment.

The above embodiments merely describe the preferred method of the present disclosure and do not limit the scope of the present disclosure. On the premise of not departing from the design spirit of the present disclosure, all kinds of deformations and improvements made by those skilled in the art to the technical solutions of the disclosure should be within the scope of protection determined by the claim of the present disclosure.

1. A modular retaining wall structure used for pool segmentation of an underwater vibration table, comprising multiple retaining wall units arranged in a matrix, the retaining wall units comprise back frame structures and bracket structures, any one of the back frame structures is positioned and connected between the two bracket structures, and water retaining plates are arranged on upstream faces of two sides of the connection between the back frame structures and the bracket structures; and when building the retaining wall units, outer sides of the back frame structures located on two sides are closely connected to side walls of a pool, and the bracket structures are arranged and plugged into the back frame structures; and
the bracket structure comprises a bottom plate and a steel frame, a bottom of the steel frame is welded with the bottom plate, an exposed end of the bottom plate is tightly connected to embedded parts of a pool bottom plate by bolts, and two sides of the steel frame are connected to water retaining plates of the bracket structures.

2. The modular retaining wall structure used for pool segmentation of the underwater vibration table according to claim 1, wherein the retaining wall units comprise N back frame structures and N+1 bracket structures, where N is an integer.

3. The modular retaining wall structure used for pool segmentation of the underwater vibration table according to claim 1, wherein the steel frame comprises frame columns and frame beams, and the frame columns and the frame beams are vertically distributed; and the frame columns placed vertically and the frame beams placed horizontally are made of H-shaped steel, and a bottom end of the frame columns is positioned and connected to the bottom plate.

4. The modular retaining wall structure used for pool segmentation of the underwater vibration table according to claim 3, wherein the back frame structure comprises steel trusses and cover plates, one steel truss is welded into a rectangular truss by multiple square pipes, the cover plates are made of square steel plates, the cover plates are arranged at two ends of vertical web rods at outermost four corners of the rectangular truss, the vertical web rods at the four corners of the rectangular truss are embedded in U-shaped grooves connected to the frame columns placed vertically, and one side of the steel truss is connected to a water retaining plate of the back frame structure.

5. The modular retaining wall structure used for pool segmentation of the underwater vibration table according to claim 4, wherein both the water retaining plates of the back frame structures and the water retaining plates of the bracket structures are made of PVC plastic plates, and the water retaining plates of the back frame structures and the water retaining plates of the bracket structures are respectively bonded or rolled on upstream faces of two sides of the steel truss and the steel frame by glue.

6. The modular retaining wall structure used for pool segmentation of the underwater vibration table according to claim 5, wherein a thickness of the water retaining plates of the back frame structures is set to a sum of a plate thickness of the water retaining plates of the bracket structures and a plate thickness of the frame columns.
